(19) United States
(12) Patent Application Publication
(10) Pub. No.: US 2008/0048027 A1
(43) Pub. Date: Feb. 28, 2008

(54) Automatic vending emulating public houses

(76) Inventors: Shuki Gabay, Jerusalem (IL); Netanel Werner, Jerusalem (IL); Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 11/509,427

(22) Filed: Aug. 25, 2006

(51) Int. Cl. G06F 7/08

(52) U.S. Cl. 235/381

(57) ABSTRACT

A system for automatically vending products and services to customers, emulating the services of a public house (pub) or a bar at a location remote from a pub or bar, by providing alcoholic beverages as well as other products, and by providing services including the obtaining relevant information from the customers. The system enables the customer to act like a vendor, taking part in the physical process of drawing the said beverages from their supply source into the drinking vessel provided. Likewise in the case of soft ice cream, the customer could emulate an ice cream vendor by drawing the said ice cream from its supply source into the container provided.

### BACKGROUND OF THE INVENTION

The present invention relates generally to a system for automatically vending products or services as provided in bars.

Bars and pubs (public houses) are well known establishments where certain products and services are provided for customers. The products provided comprise for example, alcoholic beverages, non-alcoholic beverages, cigarettes, ice cream and food. The services comprise for example, providing the said products, the playing of music, video or games.

It is desirable to vend some of the said products or to provide some of the said services only after certain information has been provided by the customer. For example, age-restricted products, such as alcohol and cigarettes, or to play age restricted video or games.

Conventional non-automated bars and pubs are usually labor intensive. They require human labor to provide the products and services and to collect payments for them. They also require human labor to collect information from the customers.

Additionally, conventional bars and pubs provide their services at specific locations and at specific times. Customers who desire the said products or services but are located at a remote location or desire them out of regular opening hours, and therefore cannot obtain them and are forced to obtain the said products or services by other means or manage without them.

These two drawbacks cause a significant loss of potential income to the conventional bars and pubs, and are highly undesirable.

Automated machinery is well known in the art to provide products and services, and to obtain information and payment from customers. Automated machinery is found at a variety of locations, for example, streets, parks, universities, hotel rooms, transportation terminals and so on. However, prior art automated machinery fails to provide the products and services of a bar or pub and do not provide a user-experience similar to that of a conventional bar or pub. Furthermore, automated machinery is, generally, economically sound as it usually sells its products and services at a price no less than conventional establishments despite there being a significant saving of manpower costs.

Some examples of prior approaches to this problem or related problems can be found in the following U.S. patents, all of which are incorporated herein by reference in their entirety: U.S. Pat. No. 5,150,817 issued to Livingstone discloses methods and apparatus for dispensing articles, U.S. Pat. No. 450,938, issued to Rademarcher discloses a card or cash actuated vending machine assembly, U.S. Pat. No. 5,769,271 issued to Miller discloses apparatus and methods for monitoring a beverage dispenser, in particular a counter system. U.S. Pat. No. 6,375,042 issued to Goodwin discloses a beverage-distributing unit. U.S. Pat. No. 6,845,907 issued to Enright discloses a cash delivery apparatus for motor fuel dispenser or other self-service facility. U.S. Pat. No. 6,854,642 issued to Metcalf et.al. discloses a system for vending products and services using an identification card and associated methods.

Beer is well known to be served in conventional bars and pubs, and is known to be served by automated machinery, as shown in part of the above US Patents. However, existing automated machinery fails to provided the user experience provided by a bar or pub to a consumer. This drawback is especially significant in the case of beer, a method of providing beer effects its taste to many discerning consumers. Conventional bars and pubs usually use equipment for storing and serving beer comprising three parts as follows; A barrel stores beer in best condition, a pipe leads the beer from the barrel, and a tap controls the flow of beer. Pressured gas is used force the beer up the pipe and out of the tap.

An additional optional product that could be served from a device such as proposed by this invention is soft ice cream. Similar conditions apply to such ice cream as to beer and other beverages, as are herein described. It would be an added attraction to buy soft ice-cream if the purchaser can take part in the serving process by for example, pulling a handle to cause the ice-cream to be dispensed into a cone or cup.

There exists a need for an automatic system for vending products or services simulating the user-experience provided by conventional establishments and conventional equipment, being a system deployable at many locations.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

Disclosed is a system for automatically vending products and services to customers, emulating the services of a public house (pub) or a bar at a location remote from a pub or bar, by providing alcoholic beverages as well as other products, and by providing services including the obtaining relevant information from the customers.

The said products and services are provided by a local unit at a remote location, a location distinct from the location of a conventional pub or bar. A conventional establishment provides manual services, employing human bartenders, waiters and the like. The local unit of this invention provides similar products and services automatically, without resorting to human labor, except for the periodical service of the machinery, refilling of stocks, and collecting accumulated cash payments and tokens and repair when necessary.

Alcoholic beverages or other products and services are offered to customers at a remote location. They are served in a manner as close as possible to that of a conventional establishment, and using equipment similar to that of conventional establishment. In particular, beer could be stored at the remote location in containers similar to barrels used in conventional establishments, served to the customer via similar pipes, and its flow could be controlled by similar taps.

Other beverages, ice cream, food, music, video clips, games and the like can also be offered to customers at the remote location, each in the manner best emulating the experience of the user of the services of a conventional establishment.

Serving some products and services require obtaining information from the customer, for example for age verification. The system could make use of tokens, which the customer may obtain at a conventional pub or bar or by other means for this purpose.

Another aspect of this invention could be for there to be a simulation, three dimensional, pictorial or digital, of an image or model on top of or on at least one side of the said local unit. The said image or model could be in the form an object for example a beer bottle, or the form of a person, for example, a barmaid or an ice cream salesman with his traditional large white hat. The said image or model could be static or could move. Its movement could co-inside with the pulling of a handle by the customer to mimic the act for example, of a barmaid who pulls a long handle in order to draw the beer from the barrel. In the case of soft ice cream, the customer could pull a physical handle to fill a cup or cone with ice cream and the image or model of an ice cream server could mimic the same movement as the customer. Such an image or model for example, could have musical accompaniment or could give vocal instruction how to operate the said local unit or announce warnings or restrictions regarding age limits when serving alcoholic beverages or advertise the other products and services available at that local unit. In addition, a sensing device like for example, an electronic eye could be used to operate when a person passes by, to play music to catch the persons attention and/or a recorded voice could advertise the products and services sold by the machine. There could also be a light display or an option to choose a video and watch it on a screen attached to the device of this invention. The said image, model, movements, music, video and lights would act as an attraction for customers, thereby increasing sales and advertising income.

Yet another aspect of the invention is to have a defense mechanism against vandalism by for example, when the machine is hit or otherwise interfered with in a way or with such force that is defined to be vandalism or potential theft, a phone-call or SMS message would be sent to a pre-determined recipient.

### BRIEF DESCRIPTION OF DRAWINGS

The accompanying drawings, which are incorporated in and form a part of this specification, illustrate embodiments of the invention and, together with the description, serve to explain, by way of non-limiting example only, the principles of the invention whereby:

FIG. 1 shows a block diagram showing the basic steps involved in the operating of a vending machine of this invention and,

FIG. 2 shows detail of a part of the system comprising a barrel, a pipe and a valve.

FIG. 3 shows a schematic depiction of an automatic vending machine emulating a public bar

### DESCRIPTION OF THE PREFERRED EMBODIMENT

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

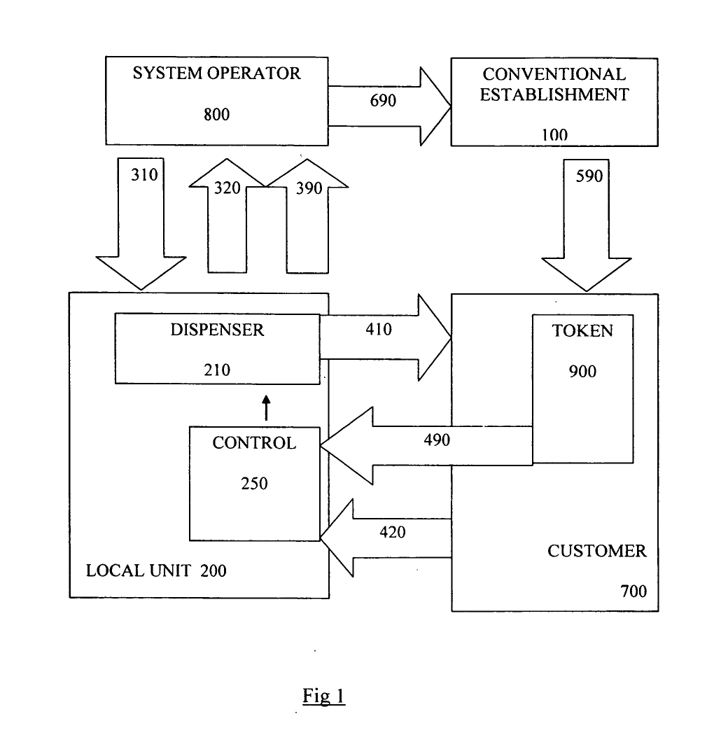

Reference is made to FIG. 1, schematically describing a system for automatically vending products and services to customers, emulating the services of a public house (pub) or a bar at a location remote from a pub or bar, by providing alcoholic beverages as well as other products and services and in addition the obtaining relevant information from the customers.

Block 100 schematically represents a conventional establishment such as a pub or a bar in which a customer may purchase products and services. The conventional establishment typically provides manual services, employing human bartenders, waiters and the like.

Block 700 schematically represents a customer.

Block 200 schematically represents a local unit, located at a specific location remote or distinct from the conventional establishment. The customer 700 may visit the conventional location 100 at certain times, and obtain products and services there, but the customer 700 visits the location of the local unit 200 at some other times, and requires similar products and services from the local unit.

The local unit 200 provides these similar products and services automatically, without resorting to human labor, except for the occasional service of the machinery, refilling of stocks, and collecting accumulated cash payments and tokens.

Arrow 410 schematically represents the products and services provided to the customer 700 by the local unit 200 at its location. These products include alcoholic beverages that are served in a manner as close as possible to that of a conventional establishment, and by equipment similar to that of conventional establishment. Other beverages, soft ice cream, food, music, television, video clips, games and the like can also be offered to customers by the local unit, each in the manner best emulating the experience of the user of the services of a pub or bar.

Arrow 420 schematically represents payment given by the customer 700 in exchange for the products or services supplied by the local unit 200. This payment can be given in the form of cash, using coins, notes, by using the credit card system or any other form of payment.

Block 800 schematically represents the operator of the system, be it a person, persons, a company or any other organization that supplies the local unit 200 with stocks of products that are stored in the local unit until served to the customer and generally attends to the various needs of the local unit to ensure its continuous operation.

Arrow 310 schematically represents the provision of products to the local unit by the operator.

The flow of products is thus described by the combination of arrows 310 and 410, from the operator to the local unit, and then from the local unit to the customer.

In the case where cash is used as a form or payment, the operator 800 periodically collects cash from the local unit 200. The flow of payment is represented by the combination of arrow 420 from the customer to the local unit, and then from the local unit to the operator, arrow 320. Credit card payments could be represented similarly except there is an electronic flow of debits and credits in favor of the operator's bank account instead of physical handling of money.

Block 900 schematically represents a token that is a carrier of information concerning the customer 700. The information is coded into the token.

Arrow 590 schematically represents the supply of a token about the customer 700 to the customer 700 at for example, a conventional establishment 100. The supply of the token to the customer could testify that someone examined and to the best of their ability determined, certain information concerning the customer. For example, the supply of a certain token to a customer could testify the age of the customer to be over a certain threshold.

Arrow 490 schematically represents the supply of such a token about the customer 700 by the customer 700 to the local unit 200. Distinction is now being made between the following three types of token. A non-recyclable token received by the local unit 200, could either cease to exit or it could turn into non-usable trash. A permanent token could be used by the same customer 700 again after being received once, without the customer needing to obtain it (Arrow 590) again. A recyclable token could be used as a token again, but only after being obtained (Arrow 590) again. This property of a token 900 is asserted at the time of the action represented by Arrow 490, and may change with time.

The following two actions are necessary in the case of tokens of the recyclable type. Arrow 390 schematically represents the collection of a token by the operator 800; and Arrow 690 schematically represents the return of a token by the operator 800. Thus, for a token of the recyclable type, the complete flow is represented by the combination of arrows 590, 490, 390 and 690 in a full cycle.

Tokens of a non-recyclable type, if they continue to exist after the action represented by Arrow 490, may be collected by the operator 800 in an action similar to that of Arrow 390 and thereafter thrown away.

Regarding the issue of trash collection, it can be viewed as a service normally provided by conventional establishments to their customers, and so it falls into the category of services provided by the local unit to its customers, as the local unit emulates the services of the conventional establishment, and in both cases the operator is responsible for removing trash from the system as a whole, in the same manner that the operator is responsible for the supply of products to the system as a whole.

The following preferred embodiments of the present invention employ a variety of tokens.

An embodiment of the present invention could employ tokens similar in shape and size to coins. The reception of such tokens by automatic machinery per-se is well known in the art. The information coded in such token can determine their shape, size, weight, electrical conductivity, color, or any other physical property. Such tokens are usually of the recyclable type.

Another embodiment of the present invention employs tokens similar in shape and size to credit cards. The reception of such tokens by automatic machinery per-se also is well known in the art. The information coded in such token can determine their magnetic properties, color, or any other physical property. Such tokens are usually of the permanent type.

Yet another embodiment of the present invention employs electromagnetic radiation as token. The reception of such tokens by automatic machinery per-se is well known in the art. Such a token could be a transmitter of a radio wave, on which information is coded using for example, AM, FM, PCM methods, or any other method. The mobile phone carried by most people today, could also be used to operate the said machinery. The phone would be able to record the pre-payment of money to the owner of the said machinery. The phone would generate an electronic wave when a specific number is dialed. This would have the effect of reducing the monetary credit by the appropriate amount and releasing the machine to be open to sell the products and services ordered and paid for. This use of the mobile phone is also known in the art.

Block 250 schematically represents the part of Block 200 that is responsible for the reception of both Token 900 and payment (arrows 490 and 420 respectively), and decoding the information. Block 250 controls the operations of other parts of Block 200, as schematically represented by the black arrow emerging from Block 250.

The control of some parts of some automatic machinery by a control unit is well known in the art per-se and may be cheaply implemented using suitably programmed embedded solid-state micro processors or micro controllers.

The algorithm implemented in Block 250 receives information detected from both payment and token as input, as well as the type of product or service required by the customer 700.

The algorithm terminates with the decision whether to allow a transaction or not, and if allowed, how much to deliver depending upon the amount ordered and paid for. Payment may be refused for example, if it is not sufficient, if there is not appropriate change available, if the requested product is out of stock, or if the token fails to confirm that the customer 700 has reached the minimum age for the sale requested. For example, the sale of beer is allowed only if proper payment is secured, and a token testifies that the customer is over some pre-defined age; the sale of milk is allowed only if proper payment is secured, regardless of the information carrier by any token; and playing a commercial video clip could be allowed regardless of payment and of token.

The algorithm implemented in Block 250 is coded to comply with the laws and moral codes prevailing at the location of the local unit, and to best prevent fraud. It is understood that fraud can never be completely prevented even at conventional establishments. For example, a customer may make a payment using counterfeit currency, or an over-age customer may obtained alcoholic beverages and resold to another, under-age person. Notices provided by local unit 200 may advise the customer 700 about the legality of such acts, by visual or audio means, for example by playing out a spoken message or by displaying a sign.

Block 210 schematically represents the part of Block 200 that is responsible for delivering the products or services requested by customer 700. It is controlled by Block 250 as explained herein above. While it is depicted by a single block for clarity, it represents a plurality of means for providing a plurality of products and services.

According to a preferred embodiment of the present invention Block 210 comprises at least one device for supplying beer.

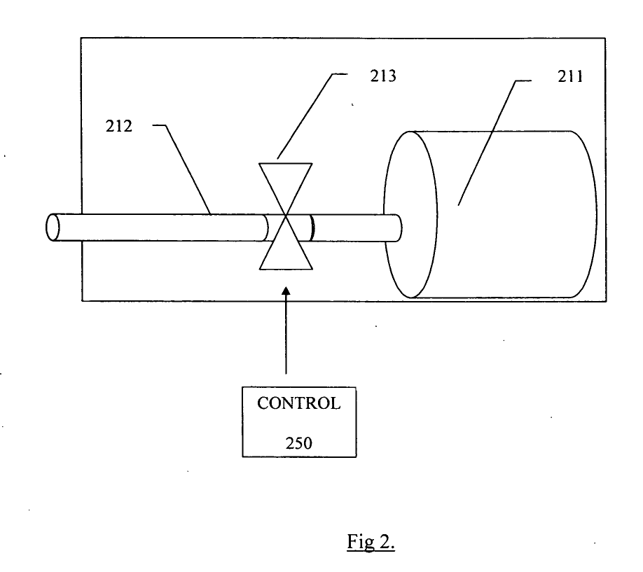

Reference is now made to FIG. 2 schematically showing Block 210 described herein above in reference to FIG. 1. Block 210 comprises the following three parts.

Part 211 is a barrel containing some liquid product. According to a preferred embodiment of the present invention, the liquid is at least one kind of beer. In the case of liquids such as beer or wine the barrel may be made of wood to produce beer or wine of the best quality, emulating beer or wine served in conventional establishments. In the case of other liquids the barrel may be made of metal, plastic, glass, cardboard or any other suitable material. Where necessary gas pressure or other suitable means is used to force the drink or ice cream up from the barrel 211, through the pipe 212 and out of the spout 210.

Part 212 is a pipe through which the liquid contained in Part 211 may flow out of Block 210, so that it is served to the customer. Pipe 212 may be made of metal, plastic, glass, or any suitable material.

Part 213 comprises a valve controlling the flow of liquid through Pipe 212. When the valve in Part 213 is turned off, liquid cannot flow in Pipe 212. Part 213 is that part of Block 210 that is controlled by Block 250, as described in reference to FIG. 1.

According to a preferred embodiment of the present invention, Part 213 comprises a valve that the customer can manually operate, in order to give the customer an experience similar to that of conventional establishments. This valve could be in the form of a handle that the customer physically pulls down towards himself and thereby the beverage is drawn up from barrel 211 into the drinking vessel of the customer 700. In the case of ice cream the customer would pull down the said handle to cause a pre-determined amount of soft ice cream to fill a cup or an ice cream cone. The quantity delivered of beverage or food like the soft ice-cream would be controlled according to the payment received and quantity ordered. When the latter two factors match that quantity and no more, of the product is made available for the customer to serve himself.

In a case where two valves are operating in Part 213, one machine controlled and the other manual, it is necessary for both to be turned on to allow the flow of liquid. This would be necessary to prevent abuse or fraud by the manual control being operated before payment and any other conditions are fulfilled.

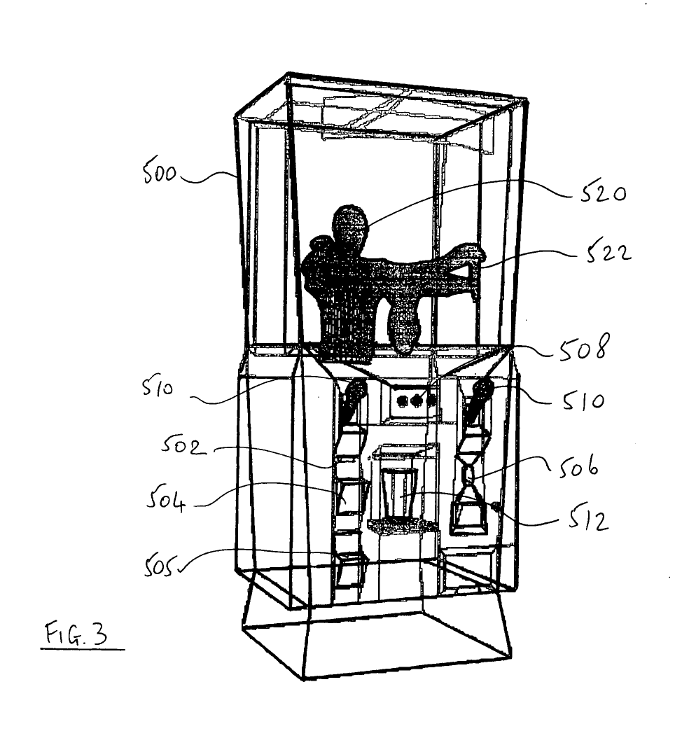

FIG. 3 is a depiction of one embodiment of this invention, namely an emulation of a public bar 500. The money to be paid for services is inserted in hole 502. Change is given in receptacle 505. In the case of payment by credit card, the relevant electronic reader 504 is provided. The said tokens, whether in the shape of coins or an electronic card, controlling the sales of services to those with a legal or moral restriction, are handled at the point 506.

The choice of beverage, soft ice cream or other services, choice of manufacturer or choice of size of drinking vessel 512 are done with the aid of buttons 508. Where beverage, especially beer, is the service chosen there could be a handle 510 emulating that used in conventional public houses. Instead of the barman or barmaid pulling the handle to draw the beverage from the barrel or other source, the customer would be able to physically pull the handle 510 that protrudes from the front face of the bar 500. After choice of type of beverage, choice of size of drinking vessel 512 and payment, the customer would pull down the handle 510 which would cause the chosen beverage to fill the vessel 512. There would be a device placed in the piping between the source of beverage and the faucet to prevent more than the chosen amount of beverage from being drawn by the handle 510. Likewise in the case of soft ice cream, the customer could pull a handle to cause the ice cream to flow out of the spout. This would be to emulate a conventional soft ice cream vending device.

The image or model 520 on top of the bar 500 could be part of an advertisement or for example be in a bottle of beer, a mug of beer or an ice cream cone, as the case may be. When, in the case of beer sales, barman 520 is an image, it could be a two dimensional image on a screen. When barman 520 is a model, it could be a three dimensional model of a barman or a barmaid. The said model 520 could be connected to the handle 510 in such a way that it would simulate the drawing of a beverage by pulling its handle 522 simultaneously with the customers pulling of handle 510. Alternatively, the said image or model could move independently or be static. There could be a simulation of beverage being poured by the said model simultaneously with the real pouring of a beverage by a customer. Alternatively, such simulated pouring could be independent of the said real pouring. The said image or model and its activities would help advertise and promote sales of beverages from such a device revealed by this invention.

When soft ice cream is sold the image or model 520 could be a traditional ice cream vendor with a big white hat. When the customer pulls the handle 510 to fill his cup or cone with ice cream, the image or model 520 could mimic the customer as described above in relation to beer sales.

The image or model 520 could be made to play musical sounds, operate a video or television, flash lights or give operating instructions to customers or warn of services that are either forbidden by law or not recommended to be sold to certain segments of the population or advertise, visually or vocally, products sold at this location.

The whole unit 500 could have wheels attached so as to be moveable by pushing or by raising one side with the aid of handles and two wheels at base of the other side.

The present invention also discloses a novel method of providing products and services at a variety of locations by means of the assembly as defined above.

### INDUSTRIAL APPLICABILITY

This invention has a potential to be applied widely. Beer, other beverages, soft ice cream, products and services herein mentioned have a high demand in nearly all countries. There is a demand for the sale of such products at times when conventional establishments are closed and in places where such establishments do not exist.

Where a video or television screen is part of the device advertising sales could increase revenues.

The price of products and services sold could be competitive because the cost of manpower per item sold is likely to be lower than that of conventional establishments. Similarly capital costs involved in this invention are likely to be lower than that of conventional establishments.

What is claimed is:

1. A moveable assembly for providing products comprising;
a means of supplying the said products automatically from a machine,
the customer desiring the said products, fulfilling certain conditions,
an image and/or a three dimensional model on or in the said assembly whereby the said assembly, image and/or model emulates similar permanent assemblies where similar products and/or services are sold and whereby the said image and/or model emulates people who provide similar services in the said permanent assemblies.

2. An assembly according to claim 1, wherein the said products are services.

3. An assembly according to claim 1, wherein the said products are beverages.

4. An assembly according to claim 1, wherein the said products are food.

5. An assembly according to claim 1, wherein the said products are soft ice cream.

6. An assembly according to claim 1, further comprising a device for playing music.

7. An assembly according to claim 1, further comprising a device for playing games and/or viewing video films and/or television.

8. An assembly according to claim 1, further comprising a lighting system, causing lights to shine from and/or on the said assembly.

9. An assembly according to claim 1, wherein there is a means for age verification.

10. An assembly according to claim 9, wherein the means for age verification is accomplished with the aid of tokens.

11. An assembly according to claim 10, employing a means for the automatic and/or electronic examining of the said tokens and only if given conditions are met will the said machine provide the products or services that require the said conditions.

12. An assembly according to claim 11, wherein said tokens are provided by people who will only issue tokens to those who meet the pre-determined conditions like for example, the age of the potential customer, or will only issue the type of token that will provide the products or services that that particular potential customer is entitled to receive according to the Law or other criteria.

13. An assembly according to claim 1, wherein the said machine comprises a barrel for storing beverages, a pipe in through which said beverages flow from said barrel, a means to force the said beverage from the said barrel through the said pipe to the faucet and a valve to control said flow.

14. An assembly according to claim 1, wherein the said machine comprises a container for storing soft ice cream, a pipe in through which said ice cream flows from said container, a means to force the said beverage from the said barrel through the said pipe to the faucet and a valve to control said flow.

15. An assembly according to claim 1, providing notice in writing or verbally to the said customer concerning the legality or morality of the purchase or consumption of the provided products and services.

16. An assembly according to claim 1 wherein there is at least one handle protruding from the said assembly which, when pulled, controls the flow of beverage from the assembly to a drinking vessel.

17. An assembly according to claim 1 wherein there is at least one handle protruding from the said assembly which, when pulled, controls the flow of soft ice cream from the said assembly to a container.

18. An assembly according to claim 1 wherein there is an image and/or a model of a barman or barmaid on the said local unit that can imitate the action of a real barman at the time of the serving of a beverage.

19. An assembly according to claim 1 wherein there is an image and/or a model of an ice cream vendor on the said local unit that can imitate the action of a real ice cream vendor at the time of serving ice cream.

20. A barman and/or an ice cream vendor as claimed in claims 18 and 19 that could imitate a person singing and/or giving instructions or other information to persons in the area on a constant basis or at regular intervals or such imitation being initiated by an electronic detection device activated by potential customers passing by.

21. An assembly according to claim 1 wherein there is a video or television device and screen on or as an integral part of the said assembly to enhance the sales of the said services.

22. An assembly according to claim 1 wherein the said assembly is moveable on at least one wheel.

23. An assembly according to claim 1 wherein the said assembly is moveable with the aid of handles.

24. An assembly according to claims 16 and 17 further comprising at least one electrically operated button instead of the said handles, to control the said flow.

25. An assembly according to claim 1 wherein an electronic sensor detecting device in or on the said assembly detects a force used on the said assembly that would be deemed to be a sign of vandalism or theft thereby causing a telephone or SMS message to be sent to a designated phone number.

26. A method of automatically providing products and services at a variety of locations by means of the assembly as herein defined in the independent claims or in any of their dependent claims.
